(19) United States
(12) Patent Application Publication
(10) Pub. No.: US 2024/0396464 A1
(43) Pub. Date: Nov. 28, 2024

(54) INTELLIGENT POWER DISTRIBUTION AND REGULATION

(71) Applicant: Amber Semiconductor, Inc., Dublin, CA (US)

(72) Inventor: Mark Telefus, Orinda, CA (US)

(21) Appl. No.: 18/674,058

(22) Filed: May 24, 2024

Related U.S. Application Data
(60) Provisional application No. 63/469,210, filed on May 26, 2023.

(51) Int. Cl. H02M 5/293; H02H 7/12; H05B 47/20

(52) U.S. Cl. CPC H02M 5/2932; H02H 7/1216; H05B 47/20

(57) ABSTRACT

A system comprises first, second, third, and fourth nodes, a plurality of control cells, and a system controller. The first and second nodes are configured to couple to an AC power source. The third and fourth nodes are configured to couple to a load. The plurality of control cells comprises a first control cell coupled to and between the first and third nodes, a second control cell coupled to and between the second and fourth nodes, a third control cell coupled to and between the first and second nodes, and a fourth control cell coupled to and between the third and fourth nodes. The system controller is coupled to each control cell of the plurality of control cells, and configured to program the plurality of control cells to implement respective functions for controlling AC power from the AC power source to the load.

### CROSS-REFERENCE TO RELATED APPLICATION

This application claims the benefit of U.S. Provisional Application Ser. No. 63/469,210, filed on May 26, 2023, the disclosure of which is incorporated herein by reference.

### BACKGROUND

This disclosure relates generally to techniques for controlling and regulating alternating current (AC) power to loads. Various types of electrical devices are utilized to control AC power delivery to load circuits or electrical components. Such electrical devices include, e.g., circuit breakers, light switches, dimmer switches, speed control devices (e.g., motor speed control, fan speed control, etc.), surge protection devices, etc., which are configured to implement specific functions for AC power control and regulation for the target application.

### SUMMARY

Exemplary embodiments of the disclosure include techniques for intelligently controlling and regulating AC power to loads.

For example, an exemplary embodiment includes a system which comprises a first node, a second node, a third node, a fourth node, a plurality of control cells, and a system controller. The first and second nodes are configured to couple to an alternating current (AC) power source. The third and fourth nodes are configured to couple to a load. The plurality of control cells comprises a first control cell coupled to and between the first node and the third node, a second control cell coupled to and between the second node and the fourth node, a third control cell coupled to and between the first node and the second node, and a fourth control cell coupled to and between the third node and the fourth node. The system controller is coupled to each control cell of the plurality of control cells, and configured to program the plurality of control cells to implement respective functions for controlling AC power from the AC power source to the load.

Another exemplary embodiment includes an electrical device which comprises a first node, a second node, a third node, a fourth node, and an intelligent control system. The first and second nodes are configured to couple the electrical device to an AC power source. The third node and the fourth node are configured to couple the electrical device to a load. The intelligent control system is configured to control operations of the electrical device. The intelligent control system comprises a plurality of control cells, and a system controller. The plurality of control cells comprises a first control cell coupled to and between the first node and the third node, a second control cell coupled to and between the second node and the fourth node, a third control cell coupled to and between the first node and the second node, and a fourth control cell coupled to and between the third node and the fourth node. The system controller is coupled to each control cell of the plurality of control cells. The system controller is configured to: program the first control cell and the second control cell to implement functions for connecting and interrupting AC power to the load; program the third control cell to implement functions for protecting against power surges applied to the first and second nodes; and program the fourth control cell to implement functions for isolating the load from leakage current that flows through the first control cell or the second control cell when deactivated to interrupt the AC power to the load.

Another exemplary embodiment includes a method for implementing intelligent power distribution and regulation. AC power is applied to an electrical device comprising an intelligent control system. The intelligent control system is configured to control operations of the electrical device. The intelligent control system comprising: a system controller; and a plurality of control cells coupled to the system controller, the plurality of control cells comprising a first control cell coupled to and between a first node and a third node, a second control cell coupled to and between a second node and a fourth node, a third control cell coupled to and between the first node and the second node, and a fourth control cell coupled to and between the third node and the fourth node. The intelligent control system is configured to control operations of the electrical device comprises the system controller determining a device type of the electrical device, and the system controller communicating with the plurality of control cells to configure the control cells to perform respective functions for controlling the AC power to a load coupled to the electrical device.

Other embodiments will be described in the following detailed description of exemplary embodiments, which is to be read in conjunction with the accompanying figures.

### BRIEF DESCRIPTION OF THE DRAWINGS

FIG. 1 schematically illustrates an intelligent power distribution and regulation system, according to an exemplary embodiment of the disclosure.

FIG. 2 schematically illustrates the intelligent power distribution and regulation system of FIG. 1 which is configured to implement functions for a given application, according to an exemplary embodiment of the disclosure.

FIG. 3 schematically illustrates an exemplary architecture of a control cell of an intelligent power distribution and regulation system, according to an exemplary embodiment of the disclosure.

FIGS. 4A and 4B schematically illustrate embodiments of solid-state AC switches that can be implemented in a control cell, according to exemplary embodiments of the disclosure.

FIG. 5 illustrates a flow diagram of a method for implementing intelligent power distribution and regulation, according to an exemplary embodiment of the disclosure.

### DETAILED DESCRIPTION

Embodiments of the disclosure will now be described in further detail with regard to techniques for intelligently controlling and regulating AC power to load circuits and/or electrical devices. As explained in further detail below, exemplary embodiments of the disclosure include, e.g., an intelligent power distribution and regulation device which has a programmable architecture that allows the intelligent power distribution and regulation device to be configured to perform various functions such as power regulation and control, power interruption, power surge protection, etc., as desired, for a target application (e.g. intelligent circuit breaker, intelligent dimmer switch, intelligent surge protection, etc.).

It is to be understood that the various features shown in the accompanying drawings are schematic illustrations that are not drawn to scale. Moreover, the same or similar reference numbers are used throughout the drawings to denote the same or similar features, elements, or structures, and thus, a detailed explanation of the same or similar features, elements, or structures will not be repeated for each of the drawings. Further, the term “exemplary” as used herein means “serving as an example, instance, or illustration.” Any embodiment or design described herein as “exemplary” is not to be construed as preferred or advantageous over other embodiments or designs.

Further, it is to be understood that the phrase “configured to” as used in conjunction with a circuit, structure, element, component, or the like, performing one or more functions or otherwise providing some functionality, is intended to encompass embodiments wherein the circuit, structure, element, component, or the like, is implemented in hardware, software, and/or combinations thereof, and in implementations that comprise hardware, wherein the hardware may comprise discrete circuit elements (e.g., transistors, inverters, etc.), programmable elements (e.g., application specific integrated circuit (ASIC) devices, field programmable gate array (FPGA) devices, etc.), processing devices (e.g., central processing unit (CPU) devices, graphical processing unit (GPU) devices, microcontroller devices, etc.), one or more integrated circuits, and/or combinations thereof. Thus, by way of example only, when a circuit, structure, element, component, etc., is defined to be configured to provide a specific functionality, it is intended to cover, but not be limited to, embodiments where the circuit, structure, element, component, etc., is comprised of elements, processing devices, and/or integrated circuits that enable it to perform the specific functionality when in an operational state (e.g., connected or otherwise deployed in a system, powered on, receiving an input, and/or producing an output), as well as cover embodiments when the circuit, structure, element, component, etc., is in a non-operational state (e.g., not connected nor otherwise deployed in a system, not powered on, not receiving an input, and/or not producing an output) or in a partial operational state.

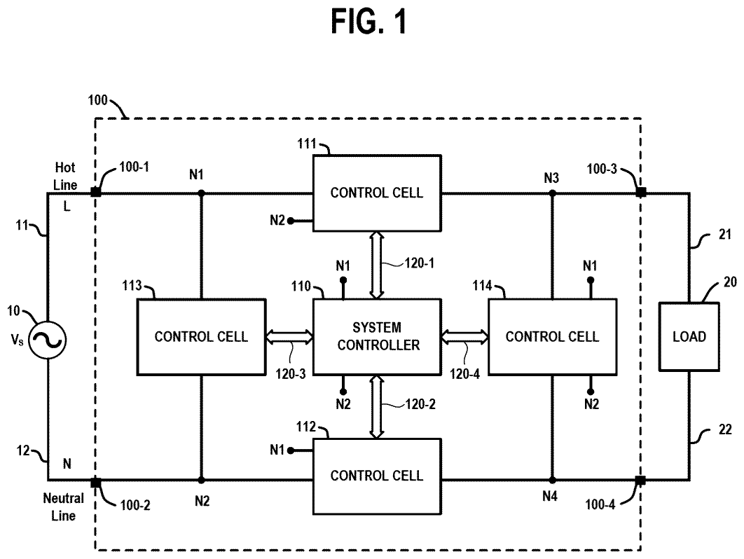

FIG. 1 schematically illustrates an intelligent power distribution and regulation system, according to an exemplary embodiment of the disclosure. In particular, FIG. 1 schematically illustrates an intelligent power distribution and regulation system 100 which is configured to control AC power that is supplied from an AC power source 10 to a load 20. In some embodiments, the AC power source 10 comprises a utility power source (e.g., AC mains), wherein the AC power source 10 is coupled to a hot (L) line 11 (e.g., a hot phase of the AC mains), and a neutral (N) line 12 (e.g., a neutral phase of the AC mains). In some embodiments, the AC power source 10 comprises a utility power source (e.g., AC mains) which provides an AC supply voltage waveform Vs with a frequency of 60 Hz and a voltage of 120 VRMS (a peak value of about 170V). For example, in some embodiments, such as in the United States, the AC power source 10 comprises a utility power supply (e.g., AC mains) which provides, e.g., a single-phase AC voltage waveform with a nominal line frequency of 60 Hz and a peak voltage of 120V RMS (a peak voltage of about 170V). In other embodiments, such as in Europe, the AC power source 10 comprises a utility power supply which provides, e.g., a single-phase AC voltage waveform with a nominal line frequency of 50 Hz and a voltage of 230V RMS. For illustrative purposes, exemplary embodiments will be discussed in the context of intelligent power distribution and regulation techniques for single-pole devices (e.g., single-pole circuit breakers, single-pole electrical switches, etc.) although it is to be understood the exemplary intelligent power distribution and regulation techniques as disclosed herein can be readily adapted for use with double-pole devices (e.g., double-pole circuit breakers, etc.).

As schematically shown in FIG. 1, the intelligent power distribution and regulation system 100 comprises a first power input terminal 100-1 (or node N1), a second power input terminal 100-2 (or node N2), a first load terminal 100-3 (or node N3), a second load terminal 100-4 (or node N4), a system controller 110, and a plurality of control cells including a first control cell 111, a second control cell 112, a third control cell 113, and a fourth control cell 114. The first and second power input terminals 100-1 and 100-2 are configured to connect the intelligent power distribution and regulation system 100 to the respective hot and neutral lines 11 and 12. The first and second load terminals 100-3 and 100-4 are configured to connect the intelligent power distribution and regulation system 100 to a load hot line 21 and a load neutral line 22, respectively, of the load 20, wherein the load 20 generically represents, e.g., an electric device or appliance, a branch circuit comprising one or more electrical devices, etc.

As schematically shown in FIG. 1, the first control cell 111 is coupled to and between the nodes N1 and N3. The second control cell 112 is coupled to and between the nodes N2 and N4. The third control cell 113 is coupled to and between the nodes N1 and N2. The fourth control cell 114 is coupled to and between the nodes N3 and N4. In this exemplary configuration, as discussed in further detail below, the control cells 111, 112, 113, and 114 provides a methodology to control and regulate power from the AC power source 10 to the load 20, while providing power control, interruption, and protection over and in-between the power lines. In other embodiments, the intelligent power distribution and regulation system 100 can be implemented with a 240V circuit in which the mains AC power is supplied over two hot lines L1 and L2 coupled to the respective terminals 100-1 and 100-2 of intelligent power distribution and regulation system 100, as opposed to the single hot line 11 and neutral line 12 connected to the respective terminals 100-1 and 100-2.

The intelligent power distribution and regulation system 100 further comprises a plurality of data communications buses 120-1, 120-2, 120-3, and 120-4 (generally denoted 120-i). In particular, the first control cell 111 and the system controller 110 communicate over a first data communications bus 120-1. The second control cell 112 and the system controller 110 communicate over a second data communications bus 120-2. The third control cell 113 and the system controller 110 communicate over a third data communications bus 120-3. The fourth control cell 114 and the system controller 110 communicate over a fourth data communications bus 120-2. The system controller 110 and the control cells 111, 112, 113, and 114 each implement a communications interface (e.g., serial input/output (I/O) interface, or parallel I/O interface) to communicate over the respective data communications buses 120-1, 120-2, 120-3, and 120-4.

Furthermore, in some embodiments, the system controller 110 comprises wireless communications circuitry that is configured to enable communication between the system controller 110 and one or more remote computing devices and systems (e.g., computer or smart electrical device). In some embodiments, the wireless communications circuitry comprises transceiver circuitry, which can implement proprietary or standard wireless communication protocols such as Wi-Fi®, near-field communication (NFC), Bluetooth®, Bluetooth Low Energy (BLE), or ZigBee®, and other types of standards-based wireless mesh networks. In some embodiments, the wireless communication and networking functions of the system controller 110 are configured to enable ad-hoc network communication between network adjacent smart electrical devices, and communicating with other network nodes which operate as edge computing nodes to collect and process data to implement one or more applications. The wireless communication circuitry of the system controller 110 allows the intelligent power distribution and regulation system 100 to be programmed/configured remotely from any wireless connectivity platform.

In general, the system controller 110 is configured to program the control cells 111, 112, 113, and 114 (e.g., on power up) to perform respective functions for a target implementation and application (e.g., intelligent circuit breaker functions, intelligent dimmer functions, electrical motor control functions, etc.). In addition, the system controller 110 is configured to facilitate/enable communication between the control cells 111, 112, 113, and 114 during operation to coordinate/synchronize the respective functions and operations. In some embodiments, the control cells 111, 112, 113, and 114 each comprise the nominally same or similar circuit architecture. The control cells 111, 112, 113, and 114 can be programmed and configured by the system controller 110 to perform respective target functions for a given application. The control cells 111, 112, 113, and 114 can be programmed to implement intelligent functions with regard to power control and regulation, power interruption, and/or protection functions, etc.

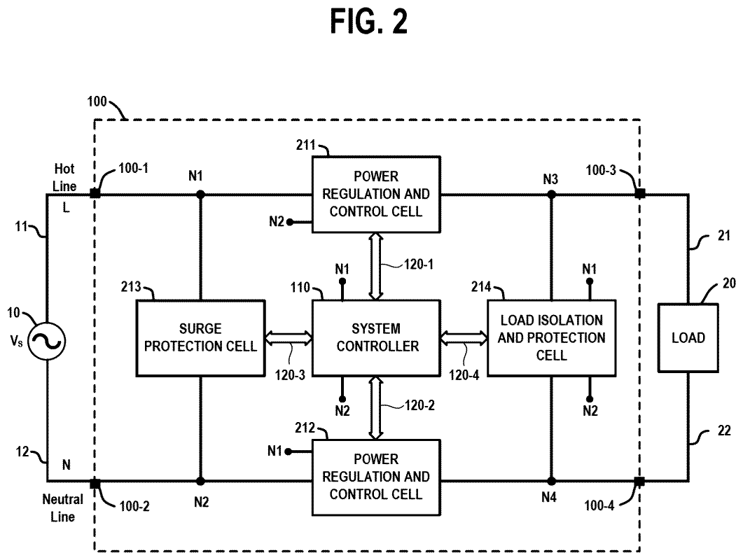

For example, FIG. 2 schematically illustrates the intelligent power distribution and regulation system 100 of FIG. 1 which is configured to implement functions for a given application, according to an exemplary embodiment of the disclosure. In particular, FIG. 2 illustrates an exemplary embodiment of the intelligent power distribution and regulation system 100 of FIG. 1 in which (i) the first control cell 111 is programmed to operate as a power regulation and control cell 211, (ii) the second control cell 112 is programmed to operate as a power regulation and control cell 212, (iii) the third control cell 113 is programmed to operate as a surge protection cell 213, and (iv) the fourth control cell 114 is programmed to operate as load isolation and protection cell 214. The power regulation and control cells 211 and 212 are each configured to control and regulate power that is delivered from the AC power source 10 to the load 20. The surge protection cell 213 is configured to protect against power surges that are applied to the first and second power input terminals 100-1 and 100-2 as a result of, e.g., voltage spikes from the AC power source 10 generation, power spike resulting from lightning strikes, etc. The surge protection cell 213 can be configured to detect for the presence of input power surges and then shunt the nodes N1 and N2 to protect the electrical components of the intelligent power distribution and regulation system 100 and to protect the load 20 from power surges. The load isolation and protection cell 214 is configured to perform functions such as load isolation and protecting the intelligent power distribution and regulation system 100 against inductive voltage feedback from the load 20 when the load comprises an inductive load, etc.

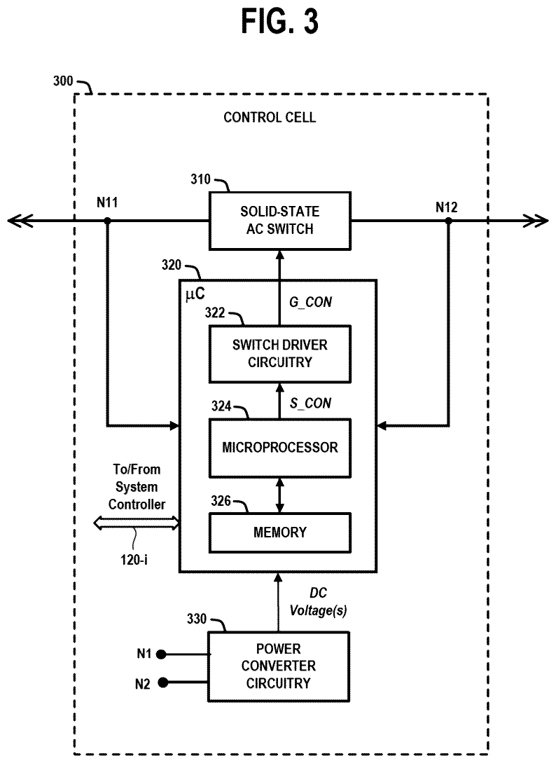

As noted above, in some embodiments, the control cells 111, 112, 113, and 114 (FIG. 1) comprise the same or similar circuit architecture, which can be programmed and configured by the system controller 110 to perform target functions. For example, FIG. 3 schematically illustrates an exemplary architecture of a programmable control cell 300 (generally, control cell 300) of an intelligent power distribution and regulation device, according to an exemplary embodiment of the disclosure. In some embodiments, each control cell 111, 112, 113, and 114 of the intelligent power distribution and regulation system 100 of FIG. 1 is implemented using the exemplary architecture of the programmable control cell 300 of FIG. 3.

The control cell 300 comprises a solid-state AC switch 310, a microcontroller 320, and power converter circuitry 330. The microcontroller 320 comprises switch driver circuitry 322, a microprocessor 324, and memory 326. It is to be noted that while not specifically shown in FIG. 3, the microcontroller 320 would comprise other components to implement various functions including, but not limited to, input/output (I/O) ports, sensor circuitry, a communication interface (e.g. serial I/O interface, parallel I/O interface), and other circuits or devices to support the exemplary control functions as described herein.

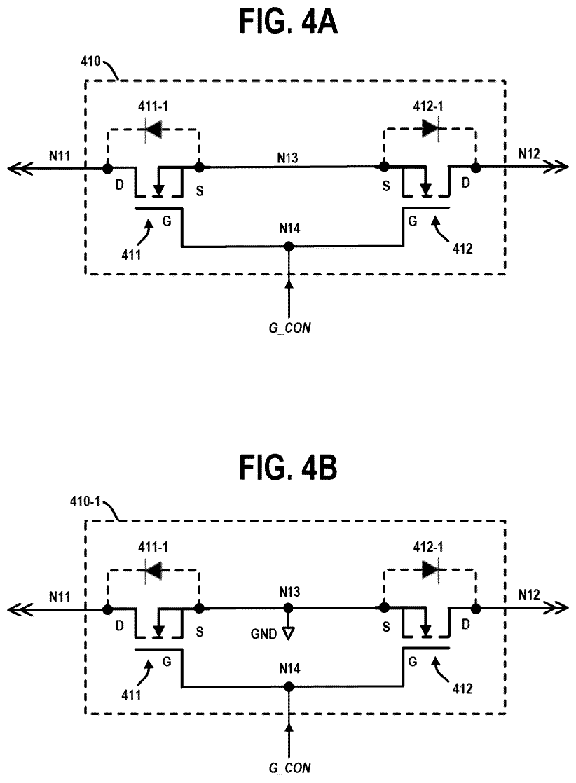

In some embodiments, the solid-state AC switch comprises a bidirectional solid-state switch that is implemented using at least two solid-state switches that are coupled back-to-back, exemplary embodiments of which will be discussed in further detail below in conjunction with FIGS. 4A and 4B. The solid-state AC switch 310 is configured to (i) allow the bidirectional flow of current between nodes N11 and N12 when the solid-state AC switch 310 is activated (or turned ON) and (ii) block/interrupt the bidirectional flow of current between the nodes N11 and N12 when the solid-state AC switch 310 is deactivated (or turned OFF). It is to be noted that for the exemplary control cells 111, 112, 113, and 114 shown in FIG. 1, the nodes N11 and N12 of the control cell 300 in FIG. 3 are coupled or otherwise correspond to either (i) the nodes N1 and N3 for the first control cell 111, (ii) the nodes N2 and N4 for the second control cell 112, (iii) the nodes N1 and N2 for the third control cell 113, or (iv) the nodes N3 and N4 for the fourth control cell 114.

The power converter circuitry 330 is configured to generate one or more DC voltages that are applied to the microcontroller 320 to provide DC supply power to the various components of the microcontroller 320. As schematically illustrated in FIG. 3, in some embodiments, the power converter circuitry 330 comprises inputs that are coupled to the hot line node N1 and the neutral line node N2 (FIG. 1) to receive as input the AC power (e.g., supply voltage Vs) that is applied to the first and second power input terminals 100-1 and 100-2 of the intelligent power distribution and regulation system 100. The power converter circuitry 330 is configured to convert AC power which is applied across the nodes N1 and N2, to one or more regulated DC supply voltages to provide DC power to operate various components of the microcontroller 320. The power converter circuitry 330 can be implemented using any suitable AC-to-DC converter circuitry to generate a regulated DC voltage, and optionally, DC-to-DC converter/regulator circuitry which is configured to convert the regulated DC voltage (which is generated by the AC-to-DC converter circuitry) into one or more industry standard DC voltages including, but not limited to 12V, 5V, 3.3 V, 2.5V, 1.8V, etc.

In some embodiments, the power converter circuitry 330 is configured to generate one or more DC voltages with a DC ground that is referenced to the neutral line at node N2, wherein DC-powered circuitry of the microcontroller 320 is ground referenced to the neutral line of the AC power. In such instance, the control cell 300 implements some form of AC-DC isolation to provide isolation or galvanic isolation (physically and electrically separate) between the AC input and DC-powered circuits. In other embodiments, as explained in further detail below, the power converter circuitry 330 is configured to generate one or more regulated DC voltages with a DC ground that is referenced to the common node connection between the back-to-back coupled solid-state switches of the solid-state AC switch 310 (e.g., FIG. 4B), in which case the neutral line input (at node N2) to the power converter circuitry 330 may not be needed.

The microcontroller 320 is configured to control the operation of the solid-state AC switch 310 to perform target functions in a manner in which the control cell 300 is programmed to operate by the system controller 110 (FIG. 1). As schematically shown in FIG. 3, the microcontroller 320 comprises inputs that are coupled to the nodes N11 and N12. The microcontroller 320 comprises sensor circuitry that is configured to sense voltage and/or current levels at the nodes N11 and N12 to perform the programmed functions/operations of the control cell 300. In some embodiments, the microcontroller 320 implements separate voltage and/or current sensor circuitry that is coupled to microprocessor 324, wherein such voltage and/or current sensor circuitry is configured to capture analog signals that represent the current and/or voltage levels at the nodes N11 and/or N12, and generate digital sensor data which represents the sensed voltage and/or current levels at nodes N11 and/or N12, and to provide the digital sensor data to the microprocessor 324 for processing to perform the programmed functions of the control cell 300.

In some embodiments, a voltage sensor can be implemented using (i) a voltage sensor device that is configured to detect a voltage level at node N11 and/or N12 using, e.g., indirect voltage detection techniques based on capacitance, inductance, magnetic coupling, etc., and (ii) a voltage sensor circuit that is configured to perform functions such as voltage level detection to determine, e.g., instantaneous voltage level, and zero-crossing detection (or voltage phase detection) to detect points in time when an AC voltage waveform crosses a zero voltage level, and the direction of polarity transition of the AC voltage waveform (e.g., transition from a positive half-cycle to a negative half-cycle, or transition from a negative half-cycle to a positive half-cycle of the AC voltage waveform). In some embodiments, a current sensor can be implemented using current sensor device (e.g., a Hall Effect sensor, or series connected current sense resistor), and associated current sensor circuitry, which are collectively configured to sense a current magnitude flowing between nodes N11 and N12, generate a voltage that is proportional to, or otherwise corresponds to, the sensed current magnitude, and detect zero-crossings of a current waveform, etc.

The microprocessor 324 is configured to generate a switch control signal (denoted S_CON), which is applied to the switch driver circuitry 322 to control the operation of the switch driver circuitry 322. In response to the switch control signal S_CON, the switch driver circuitry 322 generates a gate control signal (denoted G_CON) to control the operation of the solid-state AC switch 310, depending on programmed operation of the control cell 300. For example, in some embodiments, where the control cell 300 is configured to operate as a surge protection cell (e.g., surge protection cell 213, FIG. 2) or load isolation and protection cell (e.g., the load isolation and protection cell 214, FIG. 2), the microprocessor 324 can generate a switch control signal S_CON to cause the switch driver circuitry 322 to (i) maintain the solid-state AC switch deactivated (turned OFF) when no triggering event is detected (e.g., no power surge from AC power source 10, or no inductive flyback voltage from load 20, etc.), or (ii) activate (turn ON) the solid-state AC switch when a given triggering event is detected (e.g., detected power surge from AC power source 10, or detected inductive flyback voltage from load 20, etc.).

Moreover, in some embodiments, where the control cell 300 is configured to operate as a power regulation and control cell (e.g., power regulation and control cell 211 or 212, FIG. 2) for, e.g., a light dimmer application, or a motor speed control application, etc., the microprocessor 324 can generate a switch control signal S_CON to cause the switch driver circuitry 322 to generate a modulated gate control signal G_CON to modulate the amount of power delivered to the load 20, etc., using, e.g., pulse width modulation (PWM) control process. Further, in some embodiments, where the control cell 300 is configured to operate as a power regulation and control cell (e.g., power regulation and control cell 211 or 212, FIG. 2) for, e.g., a circuit breaker, or circuit interrupter application, etc., the microprocessor 324 can generate a switch control signal S_CON to cause the switch driver circuitry 322 to generate a gate control signal G_CON to (i) maintain the solid-state AC switch 310 in an activated state (turned ON) when no default condition (e.g., short-circuit condition, over-current condition, ground-fault condition, etc.) is detected, or to (ii) deactivate (turn OFF) the solid-state AC switch 310 when a given default condition or other triggering event is detected.

It is to be understood that while FIG. 3 illustrates a non-limiting exemplary embodiment in which the control cell 300 implements at least one microprocessor 324 as a programmable hardware processing device to perform intelligent control functions. In other embodiments, the control cell 300 can implement other types of programmable hardware processing devices, which are suitable to perform intelligent control functions as discussed herein, wherein the control cell 300 can implement one or more of an ASIC, an FPGA, a CPU, etc., which are configured to execute software routines, via programming by the system controller 110, to intelligently control the operation of the solid-state AC switch 310 to perform desired functions.

In some embodiments, the memory 326 comprises one or more memory devices, including, e.g., volatile random-access memory (RAM) and non-volatile memory (NVM), such as Flash memory, to store calibration data, operational data, and executable code, which is processed and executed by the microprocessor 324 to perform various intelligent operations as discussed herein, etc. For example, the memory 326 is utilized to store calibration data which is used to program the control cell 300 to perform local sensing and switch control functions, as desired, for a given application.

FIGS. 4A and 4B schematically illustrate embodiments of solid-state AC switches that can be implemented in a control cell, according to exemplary embodiments of the disclosure. In particular, FIG. 4A schematically illustrates a solid-state AC switch 410 (or bidirectional solid-state switch) which comprises a first solid-state switch 411 and a second solid-state switch 412. In some embodiments, the first and second solid-state switches 411 and 412 each comprise a metal-oxide-semiconductor field-effect transistor (MOSFET) device. In some embodiments, the first and second solid-state switches 411 and 412 each comprise N-type enhancement MOSFET device having a drain (D) terminal, source(S) terminal, and gate (G) terminal. For purposes of illustration, FIG. 4A shows the solid-state AC switch 410 coupled to and between first and second input/output nodes N11 and N12 of a given control cell (cell nodes N11 and N12). The first and second solid-state switches 411 and 412 are serially connected back-to-back with commonly connected source(S) terminals at node N13, and wherein the gate (G) terminals are commonly coupled to node N14. The drain (D) terminal of the first solid-state switch 411 is coupled to the cell node N11, and the drain (D) terminal of the second solid-state switch 412 is coupled to the cell node N12.

As further shown in FIG. 4A, the first and second solid-state switches 411 and 412 comprise intrinsic body diodes 411-1 and 412-1, respectively, where each body diode represents a P-N junction between a P-type substrate body to an N-doped drain (D) region of the MOSFET switch. The body diodes 411-1 and 412-1 are intrinsic elements of the first and second solid-state switches 411 and 412 (i.e., not discrete elements) and, thus, are shown with dashed-line connections. By connecting (shorting) a body terminal (e.g., P-type substrate) to the source terminal(S), the intrinsic diode of a given solid-state switch is maintained in a reversed-biased state when the given solid-state switch is activated (e.g., turned ON, or in a “ON” state or activated state). It is to be noted that intrinsic body-to-source diodes of the first and second solid-state switches 411 and 412 are not shown as they are shorted out by the connections between the source regions and the substrate bodies (e.g., N+ source and P-doped body junction are shorted through source metallization), or the intrinsic substrate body-to-source diode is shorted out by the common connection between the source terminal(S) and a body terminal (not shown).

Next, FIG. 4B schematically illustrates a solid-state AC switch 410-1 (or bidirectional solid-state switch) which is similar to the solid-state AC switch 410 of FIG. 4A, except that the common node N13 of the solid-state AC switch 410-1 serves as a DC ground (GND) reference node for DC power generation, as well as the DC-powered control circuitry and components of the control cell 300. In this regard, the DC voltages that are generated by the power converter circuitry 330 are ground referenced to the node N13. This allows, among other things, the switch driver circuitry 322 to directly drive the solid-state AC switch 310 with a gate control voltage (e.g., G_CON) without the need for AC-DC isolation. This contrast to the neutral (N) ground-referenced embodiments discussed herein, where AC-DC isolation circuitry would be implemented to drive the solid-state AC switch 410 of FIG. 4A. However, in the exemplary configuration shown in FIG. 4B, since the gate control signal G_CON is referenced to the common source node N13 between the first and second solid-state switches 411 and 412, the DC gate-to-source voltage V_{GS} will remain constant despite any AC voltage swing at the node N13.

While FIGS. 4A and 4B illustrate exemplary embodiments in which the solid-state AC switches 410 and 410-1 each comprise two MOSFET devices (e.g., the first and second solid-state switches 411 and 412), in some embodiments, each of the first and second solid-state switches 411 and 412 can be implemented with two or more MOSFET devices connected in parallel. This configuration enables enhanced heat dissipation and enhanced power handling. Furthermore, in some embodiments, the solid-state AC switches 410 and 410-1 can be implemented using other types of solid-state switch devices. For example, in some embodiments, the first and second solid-state switches 411 and 412 are implemented using integrated gate bipolar transistor (IGBT) devices having emitter terminals that are commonly connected at the node N13. In other embodiments, the first and second solid-state switches 411 and 412 can be implemented using other types of FET devices including, but not limited to, GaN (Gallium Nitride) FET devices, cascode GaN FET devices, silicon carbide (SiC) junction FET devices, cascode SiC junction FET devices, etc.

Referring again to FIGS. 1 and 3, the microcontroller 320 of the control cell 300 (FIG. 3) is coupled to the system controller 110 (FIG. 1) via a data communications bus 120-i. In some embodiments, as noted above, the system controller 110 (FIG. 1) comprises one or more programmable hardware processing devices (e.g., microprocessor, ASIC, FPGA, etc.) having a suitable communication interface (e.g., serial communication protocol interface) that enables the system controller 110 to communicate with the microprocessor 324 of the control cell 300, for purposes of, e.g., programming the microprocessor as needed to implement target functions for a given application, and to coordinate communication between and with other programmed control cells during real-time operation. For example, the control cells 111, 112, 113, and 114 of FIG. 1 can communicate through the system controller 110 to coordinate control functions during real-time operation. Further, in some embodiments, the system controller 110 comprises dedicated power converter circuitry (similar to the power converter circuitry 330 of FIG. 3) to generate one or more DC voltages from AC power applied to the nodes N1 and N2 to provide DC power for operating the DC-powered components of the system controller 110.

The system controller 110 is configured to program the control cells 111, 112, 113, and 114 to perform target functions that enable the intelligent power distribution and regulation system 100 to operate as one of, e.g., an intelligent solid-state circuit breaker (e.g., a double-pole, single-throw (DPST) circuit breaker, or a single-pole, single-throw (SPST) circuit breaker), an intelligent dimmer switch, an intelligent speed control device, an intelligent surge protection device, an intelligent industrial control device to control heating, cooling and air-conditioning, an intelligent motor control device, an intelligent thermostat (with or without a control wire), and other types of protection devices. While FIG. 1 illustrates an exemplary configuration in which the various components, e.g., system controller 110 and control cells 111, 112, 113, and 114 are shown as separate components, in some embodiments, some or all of such components can be packaged together to implement a system-on-a-chip (SoC) or system or as a system-in-package (SIP) device which integrates multiple functional chips in a package.

As noted above, the system controller 110 programs the functionality of the control cells 111, 112, 113, and 114 for a given application, wherein each control cell 111, 112, 113, and 114 operates independently to control its associated solid-state AC switch (e.g., solid-state AC switch 310, FIG. 3) as needed to perform the programmed functions, including, but not limited to, switching functions to implement ON/OFF control, power limitation to the load 20, short-circuit protection, over-current protection, over-voltage protection, ground-fault protection, surge protection, smart adaptation to different types of loads (e.g., inductive, capacitive, and/or resistive loads), response to remote control signals that are wirelessly transmitted from a given wireless connectivity platform, and power modulation to a load for light dimming, motor speed control, thermostat control for heating/cooling, etc. Further, the system controller 110 communicates with the control cells 111, 112, 113, and 114 to determine the operating states of such control cells 111, 112, 113, and 114, and the system controller 110 communicates the current operating state of each control cell 111, 112, 113, and 114 with one or more other control cells, as needed, to coordinate functions for the given application.

For example, for an intelligent solid-state circuit breaker application, the first and second control cells 111 and 112 can be programmed to operate as power regulation and control cells (e.g., control cells 211 and 212, FIG. 2) to regulate and control power that is delivered from the AC power source 10 to the load 20. In some embodiments, when the intelligent power distribution and regulation system 100 is configured for an intelligent solid-state circuit breaker application with the first and second control cells 111 and 112 programmed to operate as power regulation and control cells, the first and second control cells 111 and 112 can be configured to operate in manner to provide DPST power control and protection, or SPST power control and protection. For a SPST configuration, the second control cell 112 can be programmed to maintain its associated solid-state AC switch in an activated state (ON state) turned-on state, while the first control cell 111 is configured to sense for fault conditions on nodes N1 and/or N3, such as over-current fault conditions, short-circuit conditions, over-voltage conditions, and deactivate its associated solid-state AC switch to protect against such fault conditions, while the solid-state AC switch of the second control cell 112 is not deactivated.

On the other and, for a DPST configuration, the first and second control cells 111 and 112 are programed to operate as power regulation and control cells, wherein the first and second control cells 111 and 112 are each configured to sense for fault conditions at the respective nodes N1, N2, N3 and/or N4, such as over-current fault conditions, short-circuit conditions, over-voltage conditions, and deactivate its associated solid-state AC switch, when a fault condition is detected to thereby protect against such fault condition, and then cause the other control cell to deactivate its solid-state AC switch. For example, for a DPST configuration, if either the first control cell 111 or the second control cell 112 detects a fault condition and deactivates its associated solid-state AC switch, the given control cell which detects the fault condition (e.g., the first control cell 111) can signal the system controller 110 that the fault condition was detected, and the system controller 101 will communicate with the other cell (e.g., the second control cell 112) to cause the other cell to deactivate its associated solid-state AC switch.

Further, for any configuration of the intelligent power distribution and regulation system 100 in which the third control cell 113 is programmed to operate as a surge protection cell (e.g., surge protection cell 213, FIG. 2), the third control cell 113 can be programmatically configured to activate its associated solid-state AC switch and shunt the nodes N1 and N2 in a circumstance where the third control cell 113 detects a relatively persistent power surge which results from a given anomaly such as unstable power generation or lightening, etc., as opposed to a brief transient surge which is due to the power initially applied to the load 20. In this regard, the third control cell 113 can implement a surge detection protocols that allows for quick detection of a power surge through the processing of a control signal, wherein the sensing and processing by the third control cell 113 allows the associated solid-state AC switch to be activated to shunt the nodes N1 and N2 for a sufficient time to observe the surge energy between the hot line node N1 and the neutral line node N2 to determine the nature of the power surge (i.e., voltage transient on the AC power lines, often coming from lightning strikes). In addition, when the solid-state AC switch of the third control cell 113 is activated, the system controller 110 can command the first control cell 111 and/or the second control cell 112 to deactivate the associated solid-state AC switch to further protect the load 20 from the power surge, or otherwise command the first control cell 111 and/or the second control cell 112 to modulate the ON/OFF state of the associated solid-state AC switch to reduce the power to the load 20 for the duration of the transitory power surge.

On the other hand, power transients that result from short bursts of high power due to increased load demand can be handled by detecting such conditions, and cause at least one of the first and second control cells 111 and 112 to modulate the on/off state of its associated solid-state AC switch to modulate the amount of surge power due to the increased load demand and thereby, enable self-surge absorption. While the third control cell 113 activates its associated solid-state AC switch to absorbs surge energy, the system controller 110 can command the first control cell 111 to pass a limited amount of energy to the load 20 as well to further reduce the stress. In this regard, the third control cell 113 can be configured to absorb surge energy from large power supply voltage spikes and high current spikes due to increased transient current loads.

The fourth control cell 114 can be programmed to operate as a load isolation and protection cell (e.g., load isolation and protection cell 214, FIG. 2) to isolate the load 20, and eliminate leakage current to the load 20, in instances where the solid-state AC switch of the first control cell 111 and/or the second control cell 112 is deactivated. In particular, referring to FIG. 3, when the solid-state AC switch 310 of the given control cell 300 is deactivated (turned OFF), the solid-state AC switch 310 can generate a small amount of leakage current (e.g., e.g., 200 uA) which flows through the solid-state AC switch 310. For the first and second control cells 111 and 112, leakage current through any of the associated solid-state AC switches of the first and second control cells 111 and 112 can generate a sizable voltage drop across the load 20 when the load 20 comprises a high impedance load. In this instance, the fourth control cell 114 can activate its associated solid-state AC switch to shunt the nodes N3 and N4 and absorb leakage current, i.e., shunt the unwanted leakage current from the load 20, when the solid-state AC switch of either the first control cell 111, the second control cell 112, or both, is deactivated.

Moreover, the fourth control cell 114 can be configured to protect against inductive flyback voltage (inductive voltage spikes) in instances where the load 20 comprises an inductive load. In particular, it is known that switching inductive loads such as motors, relays, solenoids, etc., can result in high magnitude voltage spikes due to back EMF (electromotive force), which is typically referred to as “inductive flyback voltage.” An inductive flyback voltage is a voltage spike created by, e.g., an inductive load when power to the inductive load is abruptly disconnected. The voltage spike is generated due to the fact that, e.g., an instantaneous termination of current flow through the inductive load results in the instantaneous creation of a large voltage spike across the inductive load, wherein the voltage amplitude is generated according to the equation: V=L di/dt. Such voltage spikes generated by an inductive load can be on the order of thousands of volts, which can damage the components of the intelligent power distribution and regulation system 100.

For example, in an exemplary embodiment, the intelligent power distribution and regulation system 100 can be programmed to operate as an intelligent switch device which is configured to supply AC power to a magnetic low-voltage transformer (in which the load 20 is an inductive load) that reduces, or steps down, a higher AC voltage to an AC voltage that is less than, e.g., 30 volts (V) (e.g., steps down 120 V to 12 V or 24 V) to drive low-voltage lighting. In this regard, the fourth control cell 114 can be configured to be activated and protect against inductive flyback voltage that is generated by an inductive load when the intelligent power distribution and regulation system 100 disconnects AC power from the inductive load.

In particular, the fourth control cell 114 and the first and second control cells 111 and 112 can operate in a coordinated manner to protect against inductive flyback voltage in the presence of inductive loads. For example, when the system controller 110 commands the first control cell 111 and/or the second control cell 112 to deactivate its solid-state AC switch, or when the first control cell 111 and/or the second control cell 112 independently determines to deactivate its solid-state AC switch (e.g., due to a detected fault event, etc.), to protect against inductive flyback voltage, the associated microprocessor of the first control cell 111 or the second control cell 112 can be configured to sense and detect a zero-current crossing event at, e.g., node N3 or node N4, and then proceed to generate a control signal to deactivate the associated solid-state AC switch of the first control cell 111 and/or second control cell 112 in response to detecting the zero-current crossing. This allows AC power to be disconnected from the load 20 at a time when the current at node N3 or node N4 is detected to be zero or close to zero, to thereby prevent or minimize inductive flyback voltage from an inductive load. In response to the first control cell 111 and/or the second control cell 112 deactivating its associated solid-state AC switch, the system controller 110 commands the fourth control cell 114 to activate its associated solid-state AC switch to shunt the nodes N3 and N4 and thereby protect against leakage current and at the same time eliminate all residual flyback energy from the load 20 in instance where the load 20 is an inductive load.

For applications such as light dimmers or motor speed control or thermostat control of a heater, as noted above, the first control cell 111 and/or the second control cell 112 can be programmed to execute a PWM (pulse width modulation) process to generate a pulse width modulated switch control signal to modulate the turn-on time of the associated solid-state AC switch during positive and negative half cycles of the input AC power to thereby modulate the amount of AC power supplied to the load 20.

It is to be noted that while four control cells are shown in FIG. 1 for case of illustration, in some embodiments, multiple cells can be coupled in parallel to provide redundancy of operation, or to operate in a coordinated manner to support high voltage applications. For example, in some embodiments, multiple instances of the surge protection cell 213 (FIG. 2) can be coupled in parallel between nodes N1 and N2.

In some embodiments, the intelligent power distribution and regulation system 100 of FIG. 1 comprises a modular system (e.g., modular SoC component, or modular SIP component, etc.) which is configured for implementation with a plurality of different types of electrical devices. In particular, in some embodiments, the intelligent power distribution and regulation system 100 is a modular component that can be configured (either preconfigured, or field configured) to program the various control cells 111, 112, 113, and 114 to implement respective intelligent functions associated with any given one of the different types of electrical devices (e.g., circuit breaker device, electrical switch devices, surge protection devices, etc.

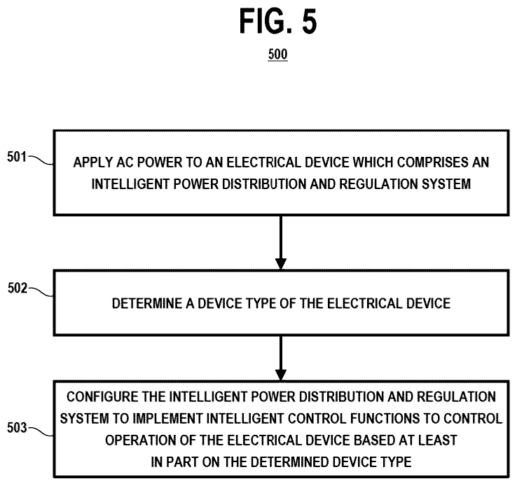

FIG. 5 illustrates a flow diagram of a method for implementing intelligent power distribution and regulation, according to an exemplary embodiment of the disclosure. In particular, FIG. 5 illustrates an exemplary method 500 for programming functions of a given electrical device which comprises, e.g., the intelligent power distribution and regulation system 100 of FIG. 1. Initially, AC power is applied to the electrical device which comprises the intelligent power distribution and regulation system 100 (block 501). Upon power-up of the intelligent power distribution and regulation system 100, the system controller 110 can execute an initialization routine that is configured to allow the system controller 110 to process calibration data and determine the device type of the electrical device (block 502). The system controller 110 can then proceed to execute a programming routine to program the control cells 111, 112, 113, and 114 and thereby configure intelligent power distribution and regulation system 100 to implement intelligent control functions to control the operation of the electrical device based at least in part on the determined device type (block 503).

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, and to enable others of ordinary skill in the art to understand the embodiments disclosed herein.

What is claimed is:

1. A system, comprising:
a first node and a second node configured to couple to an alternating current (AC) power source;
a third node and a fourth node configured to couple to a load;
a plurality of control cells comprising a first control cell coupled to and between the first node and the third node, a second control cell coupled to and between the second node and the fourth node, a third control cell coupled to and between the first node and the second node, and a fourth control cell coupled to and between the third node and the fourth node; and
a system controller, coupled to each control cell of the plurality of control cells, and configured to program the plurality of control cells to implement respective functions for controlling AC power from the AC power source to the load.

2. The system of claim 1, wherein the system controller is configured to program the control cells of the system to implement respective functions for operating one of a plurality of different types of electrical devices.

3. The system of claim 2, wherein the different types of electrical devices comprise at least one or more of a circuit breaker device, a light switch device, a motor speed control device, a surge protection device, and a heat element control device.

4. The system of claim 1, wherein the control cells comprise nominally identical circuit architectures.

5. The system of claim 1, where each control cell comprises:
a solid-state AC switch coupled to and between a first input/output node and a second input/output node of the control cell;
control circuitry configured to detect one or more of a voltage level and a current level at one or more of the first input/output node and the second input/output node and to control operation of the solid-state AC switch based at least in part on one of the detected voltage level and the current level at one or more of the first input/output node and the second input/output node; and
power converter circuitry configured to convert AC power from the AC power source to one or more DC voltages to provide DC power for operating the control circuitry.

6. The system of claim 1, wherein
the first control cell and the second control cell are programmable to implement functions for connecting and interrupting AC power source to the load;
the third control cell is programmable to implement functions to protect against power surges applied to the first and second nodes; and
the fourth control cell is programmable to implement functions to isolate the load from leakage current that may flow from the AC power source to the load through at least one of the first control cell and the second control cell when the at least one of the first control cell and the second control cell is deactivated to interrupt AC power to the load.

7. The system of claim 6, wherein the fourth control cell is further programmable to implement functions to protect against inductive voltage spikes generated by the load.

8. The system of claim 1, wherein the system controller is configured to determine an operating state of a given control cell and command at least one other control cell to change its operating state based on the determined operating state of the given control cell.

9. The system of claim 1, wherein the system controller is coupled to each control cell by a respective data communications bus, wherein each control cell is configured to communicate its operating state to the system controller over the respective data communications bus.

10. The system of claim 1, wherein the system comprises a modular component that is configured for implementation with a plurality of different types of electrical devices, and programmatically configurable to implement respective functions associated with any given one of the different types of electrical devices.

11. An electrical device, comprising:
a first node and a second node configured to couple the electrical device to an alternating current (AC) power source;
a third node and a fourth node configured to couple the electrical device to a load; and
an intelligent control system configured to control operations of the electrical device, wherein the intelligent control system comprises:
a plurality of control cells comprising a first control cell coupled to and between the first node and the third node, a second control cell coupled to and between the second node and the fourth node, a third control cell coupled to and between the first node and the second node, and a fourth control cell coupled to and between the third node and the fourth node; and
a system controller, coupled to each control cell of the plurality of control cells, and configured to: program the first control cell and the second control cell to implement functions for connecting and interrupting AC power to the load; program the third control cell to implement functions for protecting against power surges applied to the first and second nodes; and program the fourth control cell to implement functions for isolating the load from leakage current that flows through the first control cell or the second control cell when deactivated to interrupt the AC power to the load.

12. The electrical device of claim 11, wherein:
the electrical device comprises an electrical switch; and
the first control cell and the second control cell are programmed to modulate an amount of AC power that is delivered to the load.

13. The electrical device of claim 12, wherein the electrical switch comprises a light dimmer switch.

14. The electrical device of claim 11, wherein:
the electrical device comprises a circuit breaker; and
the first control cell and the second control cell are programmed to detect for an occurrence of a fault condition and interrupt AC power to the load in response to detecting the occurrence of the fault condition.

15. The electrical device of claim 11, where each control cell comprises:
a solid-state AC switch coupled to and between a first input/output node and a second input/output node of the control cell;
control circuitry configured to detect one or more of a voltage level and a current level at one or more of the first input/output node and the second input/output node and to control operation of the solid-state AC switch based at least in part on one of the detected voltage level and the current level at one or more of the first input/output node and the second input/output node; and
power converter circuitry which is configured to convert to convert AC power from the AC power source to one or more DC voltages to provide DC power for operating the control circuitry.

16. The electrical device of claim 11, wherein the system controller is configured to determine an operating state of a given control cell and command at least one other control cell to change its operating state based on the determined operating state of the given control cell.

17. The electrical device of claim 11, wherein the system controller is coupled to each control cell by a respective data communications bus, wherein each control cell is configured to communicate its operating state to the system controller over the respective data communications bus.

18. A method, comprising:
applying alternating current (AC) power to an electrical device comprising an intelligent control system; and
configuring the intelligent control system to control operations of the electrical device, the intelligent control system comprising: a system controller; and a plurality of control cells coupled to the system controller, the plurality of control cells comprising a first control cell coupled to and between a first node and a third node, a second control cell coupled to and between a second node and a fourth node, a third control cell coupled to and between the first node and the second node, and a fourth control cell coupled to and between the third node and the fourth node;
wherein configuring the intelligent control system to control operations of the electrical device comprises:
the system controller determining a device type of the electrical device; and
the system controller communicating with the plurality of control cells to configure the control cells to perform respective functions for controlling the AC power to a load coupled to the electrical device.

19. The method of claim 18, comprising the system controller communicating with the first control cell and the second control cell to configure the first control cell and the second control cell to implement functions for connecting and interrupting AC power to the load.

20. The method of claim 18, comprising:
the system controller communicating with the third control cell to configure the third control cell to implement functions for protecting against power surges applied to the first and second nodes; and
the system controller communicating with the fourth control cell to configure the fourth control cell to implement functions for isolating the load from leakage current that flows through the first control cell or the second control cell when deactivated to interrupt the AC power to the load.
